(19) United States
(12) Patent Application Publication
(10) Pub. No.: US 2026/0095816 A1
(43) Pub. Date: Apr. 2, 2026

(54) INFORMATION PROCESSING METHOD AND APPARATUS, COMMUNICATION DEVICE AND STORAGE MEDIUM

(71) Applicant: Beijing Xiaomi Mobile Software Co., Ltd., Beijing (CN)

(72) Inventors: Jinhua WU, Beijing (CN); Yang SHEN, Beijing (CN)

(73) Assignee: Beijing Xiaomi Mobile Software Co., Ltd., Beijing (CN)

(21) Appl. No.: 19/111,769

(22) PCT Filed: Sep. 16, 2022
(86) PCT No.: PCT/CN2022/119481

§ 371 Date: Mar. 13, 2025

(51) Int. Cl. H04W 28/24

(52) U.S. Cl. CPC H04W 28/24

(57) ABSTRACT

Embodiments of the present disclosure provide an information processing method and apparatus, a communication device, and a storage medium. The information processing method is executed by a function node of an access network and comprise: sending first indication information to a first network function, wherein the first indication information is used for indicating at least one of the following: packet loss event information of a QoS processing data packet based on a PDU set; and packet loss indication information of the QoS processing data packet based on the PDU set.

### CROSS-REFERENCE TO RELATED APPLICATIONS

This application is a national stage of International Application No. PCT/CN2022/119481, filed on Sep. 16, 2022, which is hereby incorporated by reference in its entirety.

### TECHNICAL FIELD

The present disclosure relates to, but is not limited to, the field of communication technologies, and in particular, to an information processing method and apparatus, a communication device, and a storage medium.

### BACKGROUND

Mobile media services, extended reality (XR) services such as augmented reality (AR) services or virtual reality (VR) services, cloud game services, video-based robots or unmanned aerial vehicle remote control services are expected to contribute an increasing amount of traffic to fifth generation mobile communication technology (5G) networks.

Currently, a quality of service (QoS) mechanism is used in a 5G core network system. Data flows of an XR service have characteristics of high bandwidth, low latency, and high reliability requirements, and need to further match QoS requirements of a data unit (for example, a packet data unit (PDU)) and a data unit set in the data flow. Meanwhile, the characteristics of the high bandwidth and low latency requirements for a multimedia extended reality (XRM) service presents a new challenge for data transferring and transmission of a radio access network (RAN) air interface.

### SUMMARY

Embodiments of the present disclosure provide an information processing method and apparatus, a communication device and a storage medium.

According to a first aspect of the embodiments of the present disclosure, an information processing method is provided, performed by an access network function node, including: sending first indication information to a first network function through a control plane (CP) function. Where the first indication information indicates at least one of: packet discarding event information of packet data unit (PDU) set based quality of service (QoS) handling; or packet discarding indication information of PDU set based QoS handling.

In some embodiments, the packet discarding event information indicates a trigger event of packet discarding that achieves condition; and/or, the packet discarding indication information indicates whether performing the packet discarding that achieves condition is needed, or whether performing the packet discarding that achieves condition is allowed.

In some embodiments, the trigger event includes at least one of: a congestion parameter indicating a level of network congestion is greater than a congestion threshold; a packet error rate is greater than a packet error rate threshold; a delay is greater than a delay threshold; a user equipment (UE) status is a predetermined status; and/or a packet discarding filter of a data flow or the PDU set or a data packet is matched.

In some embodiments, sending the first indication information to the first network function through the CP function includes: sending the first indication information to the first network function through an access and mobility management function (AMF) and a session management function (SMF).

In some embodiments, sending the first indication information to the first network function through the AMF and the SMF includes: sending the first indication information to the AMF, where the first indication information is used to be sent to the SMF by the AMF, and is used by the SMF to send second indication information to the first network function, where the second indication information carries the first indication information.

In some embodiments, sending the first indication information to the first network function through the AMF and the SMF includes: sending the first indication information to the AMF, where the first indication information is used by the AMF to send second indication information carrying the first indication information to the first network function upon receiving the first indication information.

In some embodiments, the second indication information further includes a measured report.

In some embodiments, the first network function includes a policy control function (PCF).

According to a second aspect of the embodiments of the present disclosure, an information processing method is provided, performed by a first network function, including: receiving first indication information sent by an access network function node through a control plane (CP) function. Where the first indication information indicates at least one of: packet discarding event information of PDU set based QoS handling; or packet discarding indication information of PDU set based QoS handling.

In some embodiments, the packet discarding event information indicates a trigger event of packet discarding that achieves condition; and/or, the packet discarding indication information indicates whether performing the packet discarding that achieves condition is needed, or whether performing the packet discarding that achieves condition is allowed.

In some embodiments, the trigger event includes at least one of: a congestion parameter indicating a level of network congestion is greater than a congestion threshold; a packet error rate is greater than a packet error rate threshold; a delay is greater than a delay threshold; a user equipment (UE) status is a predetermined status; or a packet discarding filter of a data flow or the PDU set or a data packet is matched.

In some embodiments, receiving the first indication information sent by the access network function node through the CP function includes: receiving the first indication information sent by the access network function node through an AMF and an SMF.

In some embodiments, receiving the first indication information sent by the access network function node through the AMF and the SMF includes: receiving second indication information carrying the first indication information sent by the SMF, where the first indication information is sent by the access network function node and is received by the AMF, and is sent to the SMF by the AMF.

In some embodiments, receiving the first indication information sent by the access network function node through the AMF and the SMF includes: receiving second indication information carrying the first indication information sent by the AMF, where the first indication information is sent by the access network function node and is received by the AMF.

In some embodiments, the second indication information further includes a measured report.

In some embodiments, the first network function includes a PCF.

In some embodiments, the method includes: sending authorization information to an SMF, where the authorization information indicates to perform packet discarding on at least one of a QoS flow, a data flow, a data unit set, or a data packet. Where the authorization information is used by the SMF to send rule information to a third network function, and the rule information is used by the third network function to perform the packet discarding on at least one of the QoS flow, the QoS flow, the data flow, the data unit set, or the data packet.

In some embodiments, sending the authorization information to the SMF includes: determining, based on the first indication information, that packet discarding needs to be performed, and sending the authorization information to the SMF.

In some embodiments, the method includes: sending notification information to a second network function; or, sending the notification information to the second network function based on received subscription information sent by the second network function. Where the notification information includes at least one of: a measured report; the packet discarding event information; or the packet discarding indication information.

In some embodiments, the second network function includes a network exposure function (NEF) or an application function (AF).

According to a third aspect of the embodiments of the present disclosure, an information processing method is provided, performed by a second network function, including: receiving notification information sent by a first network function. Where the notification information includes at least one of: a measured report; packet discarding event information of PDU set based QOS handling; or packet discarding indication information of PDU set based QoS handling.

In some embodiments, the method includes: sending subscription information to a first network function, where the subscription information is used to request notification information.

In some embodiments, the second network function includes a NEF or an AF.

According to a fourth aspect of the embodiments of the present disclosure, an information processing method is provided, performed by a third network function, including: receiving rule information sent by a session management function (SMF), where the rule information is sent by the SMF upon receiving authorization information sent by a first network function. Where the authorization information indicates to perform packet discarding on at least one of a quality of service (QoS) flow, a data flow, a data unit set, and a data packet, and the rule information is used by the third network function to perform the packet discarding on at least one of the QoS flow, the data flow, the data unit set, and the data packet.

In some embodiments, the method includes: performing packet discarding based on a PDU set parameter, or the rule information, or both.

In some embodiments, the method includes at least one of: performing packet discarding on an entire data packet of a PDU set or a part of the data packet of the PDU set based on a dependency relationship or an importance relationship of the PDU set; performing packet discarding within a packet discarding window time; performing packet discarding based on different data flow priorities; or performing packet discarding on a PDU set with a specific dependency relationship or a PDU set with a specific importance relationship.

In some embodiments, the method includes at least one of: performing packet discarding on a PDU set based on an exceeded PDU set delay budget (PSDB); performing packet discarding on a PDU set based on an exceeded PDU set error rate; performing packet discarding on a PDU set based on delivery failure of a dependent PDU set; performing packet discarding on data packet of a PDU set based on delivery failure of an important PDU set; performing packet discarding on a PDU set based on an exceeded packet delay budget (PSDB) of the PDU set; performing packet discarding on a PDU set based on an exceeded packet error rate of the PDU set; performing packet discarding on data packet of a PDU set based on delivery failure of a dependent packet in the PDU set; or performing packet discarding on data packet of a PDU set based on delivery failure of an important packet in the PDU set.

In some embodiments, the third network function includes a user plane function (UPF).

According to a fifth aspect of the embodiments of the present disclosure, an information processing apparatus is provided, including: a first sending module, configured to send first indication information to a first network function through a control plane (CP) function. Where the first indication information indicates at least one of: packet discarding event information of PDU set based QoS handling; or packet discarding indication information of PDU set based QoS handling.

In some embodiments, the packet discarding event information indicates a trigger event of packet discarding that achieves condition; and/or, the packet discarding indication information indicates whether performing the packet discarding that achieves condition is needed, or whether performing the packet discarding that achieves condition is allowed.

In some embodiments, the trigger event includes at least one of: a congestion parameter indicating a level of network congestion is greater than a congestion threshold; a packet error rate is greater than a packet error rate threshold; a delay is greater than a delay threshold; a user equipment (UE) status is a predetermined status; or a packet discarding filter of a data flow or the PDU set or a data packet is matched.

In some embodiments, the first sending module is configured to: send the first indication information to the first network function through an AMF and an SMF.

In some embodiments, the first sending module is configured to: send the first indication information to the AMF, where the first indication information is used to be sent to the SMF by the AMF, and is used by the SMF to send second indication information to the first network function, where the second indication information carries the first indication information.

In some embodiments, the first sending module is configured to: send the first indication information to the AMF, where the first indication information is used by the AMF to send second indication information carrying the first indication information to the first network function upon receiving the first indication information.

In some embodiments, the second indication information further includes a measured report.

In some embodiments, the first network function includes a PCF.

According to a sixth aspect of the embodiments of the present disclosure, an information processing apparatus is provided, including: a second receiving module, configured to receive first indication information sent by an access network function node through a control plane (CP) function. Where the first indication information indicates at least one of: packet discarding event information of PDU set based QoS handling; or packet discarding indication information of PDU set based QoS handling.

In some embodiments, the packet discarding event information indicates a trigger event of packet discarding that achieves condition; and/or, the packet discarding indication information indicates whether performing the packet discarding that achieves condition is needed, or whether performing the packet discarding that achieves condition is allowed.

In some embodiments, the trigger event includes at least one of: a congestion parameter indicating a level of network congestion is greater than a congestion threshold; a packet error rate is greater than a packet error rate threshold; a delay is greater than a delay threshold; a user equipment (UE) status is a predetermined status; or a packet discarding filter of a data flow or the PDU set or a data packet is matched.

In some embodiments, the second receiving module is configured to: receive the first indication information sent by the access network function node through an AMF and an SMF.

In some embodiments, the second receiving module is configured to: receive second indication information carrying the first indication information sent by the SMF, where the first indication information is sent by the access network function node and is received by the AMF, and is sent to the SMF by the AMF.

In some embodiments, the second receiving module is configured to: receive second indication information carrying the first indication information sent by the AMF, where the first indication information is sent by the access network function node and is received by the AMF.

In some embodiments, the second indication information further includes a measured report.

In some embodiments, the first network function includes a PCF.

In some embodiments, the apparatus includes: a second sending module, configured to send authorization information to an SMF, where the authorization information indicates to perform packet discarding on at least one of a QoS flow, a data flow, a data unit set, or a data packet;
where the authorization information is used by the SMF to send rule information to a third network function, and the rule information is used by the third network function to perform the packet discarding on at least one of the QoS flow, the data flow, the data unit set, or the data packet.

In some embodiments, the second sending module is configured to determine, based on the first indication information, that packet discarding needs to be performed, and send the authorization information to the SMF.

In some embodiments, the second sending module is configured to send notification information to the second network function; or, send the notification information to the second network function based on received subscription information sent by the second network function. Where the notification information includes at least one of: a measured report; the packet discarding event information; or the packet discarding indication information.

In some embodiments, the second network function includes a NEF or an AF.

According to a seventh aspect of the embodiments of the present disclosure, an information processing apparatus is provided, including: a third receiving module, configured to receive notification information sent by a first network function. Where the notification information includes at least one of: a measured report; packet discarding event information of PDU set based QoS handling; or packet discarding indication information of PDU set based QoS handling.

In some embodiments, the apparatus includes: a third sending module, configured to send subscription information to the first network function, where the subscription information is used to request notification information.

In some embodiments, the second network function includes a NEF or an AF.

According to an eighth aspect of the embodiments of the present disclosure, an information processing apparatus is provided, including:
a fourth receiving module, configured to receive rule information sent by a session management function (SMF), where the rule information is sent by the SMF upon receiving authorization information sent by a first network function. Where the authorization information indicates to perform packet discarding on at least one of a quality of service (QoS) flow, a data flow, a data unit set, and a data packet, and the rule information is used by the third network function to perform the packet discarding on at least one of the QoS flow, the data flow, the data unit set, and the data packet.

In some embodiments, the apparatus includes: a processing module, configured to perform packet discarding based on a PDU set parameter, or the rule information, or both.

In some embodiments, the processing module is configured to perform at least one of: performing packet discarding on an entire data packet of a PDU set or a part of the data packet of the PDU set based on a dependency relationship or an importance relationship of the PDU set; performing packet discarding within a packet discarding window time; performing packet discarding based on different data flow priorities; or performing packet discarding on a PDU set with a specific dependency relationship or a PDU set with a specific importance relationship.

In some embodiments, the processing module is configured to perform at least one of: performing packet discarding on a PDU set based on an exceeded PDU set delay budget (PSDB); performing packet discarding on a PDU set based on an exceeded PDU set error rate; performing packet discarding on a PDU set based on delivery failure of a dependent PDU set; performing packet discarding on data packet of a PDU set based on delivery failure of an important PDU set; performing packet discarding on a PDU set based on an exceeded packet delay budget (PSDB) of the PDU set; performing packet discarding on a PDU set based on an exceeded packet error rate of the PDU set; performing packet discarding on data packet of a PDU set based on delivery failure of a dependent packet in the PDU set; or performing packet discarding on data packet of a PDU set based on delivery failure of an important packet in the PDU set.

In some embodiments, the third network function includes a user plane function (UPF).

According to a ninth aspect of the embodiments of the present disclosure, a communication device is provided, including: a processor; and a memory for storing a processor-executable instruction. Where the processor is configured to: execute the executable instruction to implement the information processing method according to any embodiment of the present disclosure.

According to a tenth aspect of the embodiments of the present disclosure, a computer storage medium is provided, where the computer storage medium stores a computer-executable program, and when the executable program is executed by a processor, the information processing method of any embodiment of the present disclosure is implemented.

According to an eleventh aspect of the embodiments of the present disclosure, an information processing system is provided, including: an access network function node, a first network function, an SMF, and a third network function. Where the access network function node is configured to send first indication information to the first network function through a control plane (CP) function, where the first indication information indicates at least one of: packet discarding event information of packet data unit (PDU) set based quality of service (QoS) handling; or packet discarding indication information of PDU set based QoS handling. Where the first network function is configured to determine, based on the first indication information, that packet discarding needs to be performed, and send authorization information to the SMF, where the authorization information indicates to perform packet discarding on at least one of a QoS flow, a data flow, a data unit set, or a data packet. Where the SMF is configured to send rule information to the third network function based on the received authorization information, where the rule information is used by the third network function to perform the packet discarding on at least one of the QoS flow, the data flow, the data unit set, or the data packet. Where the third network function is configured to perform packet discarding based on a packet data unit (PDU) set parameter, or the rule information, or both.

In some embodiments, the system further includes: a second network function; where, the first network function is configured to send notification information to the second network function, where the notification information includes at least one of: a measured report, the packet discarding event information, and the packet discarding indication information; or, the first network function is configured to send notification information to the second network function based on received subscription information sent by the second network function.

According to a twelfth aspect of the embodiments of the present disclosure, an information processing system is provided, including: an access network function node, a first network function, a second network function, and a third network function, where the access network function node is configured to perform the information processing method applied to any embodiment in the access network function node, the first network function is configured to perform the information processing method applied to any embodiment in the first network function, the second network function is configured to perform the information processing method applied to any embodiment in the second network function, or the third network function is configured to perform the information processing method applied to any embodiment in the third network function.

The technical solutions provided by the embodiments of the present disclosure may include following beneficial effects.

In the embodiments of the present disclosure, the access network function node is configured to send the first indication information to the first network function through the CP function, where the first indication information indicates at least one of: the packet discarding event information of PDU set based QoS handling; or the packet discarding indication information of PDU set based QoS handling. In this way, the first indication information may notify the first network function of a packet discarding trigger event of PDU set QoS handling and whether performing the packet discarding is needed or allowed, so that the first network function can accurately determine whether packet discarding is required; and in this way, occurrence of inaccurate charging results caused by intended packet discarding of the access network function node can be reduced.

In addition, in the embodiments of the present disclosure, reporting based on the first indication information on the control plane may also be implemented through the CP function.

It should be understood that the general description and the following detailed description are only examples and illustrative, and do not limit the embodiments of the present disclosure.

### BRIEF DESCRIPTION OF DRAWINGS

FIG. 1 is a schematic structural diagram of a wireless communication system according to an example embodiment.

FIG. 2 is a flowchart of an information processing method according to an example embodiment.

FIG. 3 is a flowchart of an information processing method according to an example embodiment.

FIG. 4 is a flowchart of an information processing method according to an example embodiment.

FIG. 5 is a flowchart of an information processing method according to an example embodiment.

FIG. 6 is a flowchart of an information processing method according to an example embodiment.

FIG. 7 is a flowchart of an information processing method according to an example embodiment.

FIG. 8 is a flowchart of an information processing method according to an example embodiment.

FIG. 9 is a flowchart of an information processing method according to an example embodiment.

FIG. 10 is a flowchart of an information processing method according to an example embodiment.

FIG. 11 is a flowchart of an information processing method according to an example embodiment.

FIG. 12 is a block diagram of an information processing apparatus according to an example embodiment.

FIG. 13 is a block diagram of an information processing apparatus according to an example embodiment.

FIG. 14 is a block diagram of an information processing apparatus according to an example embodiment.

FIG. 15 is a block diagram of an information processing apparatus according to an example embodiment.

FIG. 16 is a block diagram of an information processing system according to an example embodiment.

FIG. 17 is a block diagram of a UE according to an example embodiment.

FIG. 18 is a block diagram of a base station according to an example embodiment.

FIG. 19 is a schematic diagram of a network architecture for a 5G system according to an example embodiment.

### DETAILED DESCRIPTION

Example embodiments will be described in detail herein, examples of which are illustrated in the accompanying drawings. When following description refers to the drawings, unless otherwise indicated, same numerals in different drawings indicate same or similar elements. The embodiments described in the following example embodiments do not represent all embodiments consistent with the embodiments of the present disclosure. Rather, they are merely examples of apparatuses and methods consistent with some aspects of the embodiments of the present disclosure as detailed in the appended claims.

The terminology used in the embodiments of the present disclosure is for the purpose of describing particular embodiments only and is not intended to limit the embodiments of the present disclosure. The singular forms “a/an”, “the”, and “said” used in the embodiments of the present disclosure and the appended claims are also intended to include plural forms unless the context clearly indicates other meanings. It should also be understood that the term “and/or” as used herein refers to and includes any or all possible combinations of one or more associated listed item.

It should be understood that although the terms “first”, “second”, “third”, etc., may be used to describe various information in the embodiments of the present disclosure, these information should not be limited to these terms. These terms are only used to distinguish a same type of information from each other. For example, without departing from the scope of the embodiments of the present disclosure, “first information” may also be referred to as “second information”, and similarly, “second information” may also be referred to as “first information”. Depending on context, the word “if” as used herein may be interpreted as “when” or “upon” or “in response to determining”.

FIG. 1 is a schematic structural diagram of a wireless communication system according to an embodiment of the present disclosure.

As shown in FIG. 1, the wireless communication system may include a plurality of user equipment (UE) 110 and a plurality of access network devices 120. The wireless communication system may be a 4th generation mobile communication (4G) system, also referred to as a long term evolution (LTE) system; or the wireless communication system may be a 5G system, also referred to as a new radio system or a 5G NR system. Alternatively, the wireless communication system may be a next-generation system of a 5G system, or the like.

The user equipment 110 may be a device that provides voice and/or data connectivity to a user. The user equipment 110 may communicate with one or more core networks through a radio access network (RAN), and the user equipment 110 may be Internet of Things user equipment, such as a sensor device, a mobile phone (or referred to as a “cellular” phone), and a computer having the Internet of Things user equipment, for example, may be a fixed, portable, pocket-sized, handheld, computer built-in, or in-vehicle apparatus. For example, a station (STA), a subscriber unit, a subscriber station, a mobile station, a mobile, a remote station, an access point, a remote terminal, an access terminal, a user terminal, a user agent, a user device, or a user equipment. Alternatively, the user equipment 110 may be a device of an unmanned aerial vehicle. Alternatively, the user equipment 110 may be an in-vehicle device, for example, may be a vehicle computer having a wireless communication function, or a wireless user equipment externally connected to a vehicle computer. Alternatively, the user equipment 110 may be a roadside device, for example, a street lamp, a signal light, or another roadside device having a wireless communication function.

The access network device 120 may be a network side device in a wireless communication system. The access network device 120 may be an evolved NodeB (eNB) used in a 4G system. Alternatively, the access network device 120 may be a base station (gNB) in a centralized-distributed architecture in a 5G system. Alternatively, the access network device 120 may be an access network in a 5G system, and may be referred to as a new generation-radio access network (NG-RAN). When the access network device 120 uses a centralized-distributed architecture, the access network device 120 usually includes a central unit (CU) and at least two distributed units (DU). The centralized unit is provided with a protocol stack of a Packet Data Convergence Protocol (PDCP) layer, a Radio Link Control (RLC) layer, and a Medium Access Control (MAC) layer; and the distributed unit is provided with a protocol stack of a Physical (PHY) layer, which is not limited in the embodiments of the present disclosure.

A wireless connection may be established between the access network device 120 and the user equipment 110 through a wireless air interface. In different implementations, the wireless air interface is a wireless air interface based on a fourth generation mobile communication network technology (4G) standard; or the wireless air interface is a wireless air interface based on a fifth generation mobile communication network technology (5G) standard, for example, the wireless air interface is a new air interface; or the wireless air interface may also be a wireless air interface based on a next generation mobile communication network technology standard of 5G.

In some embodiments, an E2E (End to End) connection may also be established between the user equipment 110. For example, in a scenario such as vehicle to vehicle (V2V) communication, vehicle to infrastructure (V2I) communication, and vehicle to peer (V2P) communication in vehicle to everything (V2X) communication.

The user equipment herein may be considered as a terminal device in the following embodiments.

In some embodiments, the wireless communication system may further include a core network device 130.

The plurality of access network devices 120 are respectively connected to the core network device 130. The core network device 130 may be a core network device in a wireless communication system, for example, the core network device 130 may be a mobility management entity (MME) in an evolved packet core (EPC). Alternatively, the core network device may be another core network device, for example, a serving gateway (SGW), a public data network gateway (PGW), a policy and charging rules function (PCRF), or a home subscriber server (HSS); or the core network device may be a core network device in 5G; for example, may be a policy control function (PCF) or a session management function (SMF). An implementation form of the core network device 130 is not limited in the embodiments of the present disclosure.

For ease of understanding by those skilled in the art, the embodiments of the present disclosure list a plurality of implementations to clearly describe the technical solutions of the embodiments of the present disclosure. Certainly, those skilled in the art may understand that the multiple embodiments provided by the embodiments of the present disclosure may be executed separately, or may be executed together with the methods of other embodiments in the embodiments of the present disclosure, or may be executed separately or in combination with some methods in other related technologies; the embodiments of the present disclosure are not limited thereto.

In order to better understand the technical solution described in any embodiment of the present disclosure, firstly, an application scenario applicable to the present disclosure is described.

In some application scenarios, in addition to audio and video flows, an XRM service further relates to a multimodal data flow, for example, a biotactile data flow. These multimodal data flows represent data of a service or application input from the same device or different devices (including sensors), and these data may be output to one or more destination devices. Each data flow in the multimodal data usually has a correlation, for example, synchronization between an audio flow and a video flow, and synchronization between haptic and visual. The data flows of such media services, among the data flows, and the requirements of these service data flows for network transmission all have some common features; effective identification and utilization of these features will be more conducive to the transmission and control of networks and services, and also to the service guarantee and user experience.

In some application scenarios, matching of QoS requirements of a PDU or a PDU set in a data flow generally refers to: a dependency relationship between data units in a data unit set, a dependency relationship between data unit sets, an importance relationship or priority of a data unit in a data unit set, and an importance relationship or priority of a data unit set.

In some application scenarios, XRM service characteristics of high bandwidth and low latency requirements presents new challenges for data transferring and transmission of a RAN air interface. At present, a 5G system studies how to optimize data transferring of a RAN air interface based on information such as a dependency relationship and an importance relationship or a priority between data units in a data unit set. However, when network congestion occurs, current data flow transferring mechanisms still cannot quickly relieve congestion, for example, a manner of discarding data units exceeding a QoS delay threshold during congestion directly leads to unsatisfied service QoS, and user experience (quality of experience, QoE) is greatly reduced. At present, the 5G system does not support an XR service data flow, especially network side transferring enhancement of a downlink flow.

In some application scenarios, the 5G system does not support charging corresponding to an XR service data flow QoS enhancement. For example, after the downlink data is performed with charging statistics and reporting by the UPF, the RAN function node initiatively discards remaining data packet in the data unit set and/or data packet of a related data unit set based on QoS characteristic or requirement matching between data units in the data unit set and/or between data unit sets, and initiatively discards charged data packet in batches, resulting in an inaccurate charging result. The “initiative packet discarding” herein refers to that a related network function determines by itself whether to discard the packet or not, which is different from passive packet discarding due to conditions such as network congestion. To this end, the present disclosure provides the following solution to solve the technical problem.

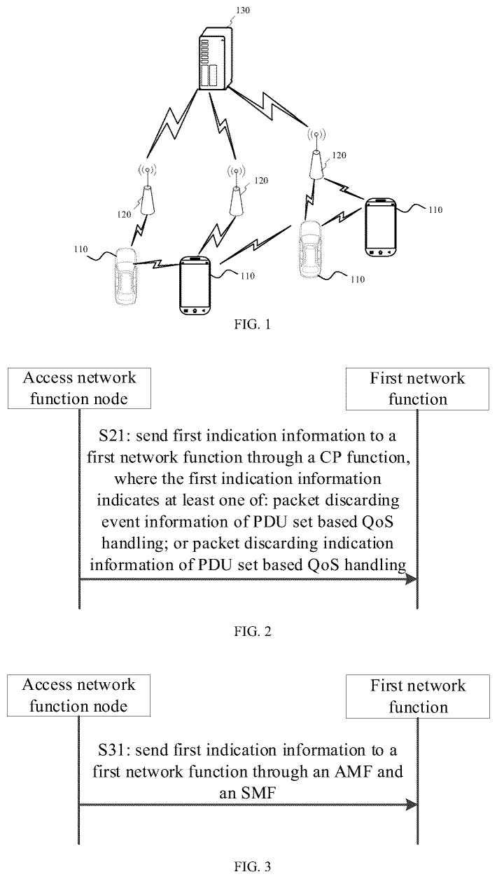

As shown in FIG. 2, an embodiment of the present disclosure provides an information processing method, performed by an access network function node, including step S21.

Step S21: sending first indication information to a first network function through a control plane (CP) function, where the first indication information indicates at least one of: packet discarding event information of packet data unit (PDU) set based quality of service (QoS) handling; or packet discarding indication information of PDU set based QoS handling.

In the embodiment of the present disclosure, the access network function node, the first network function, and a second network function, a third network function, an AMF, an SMF mentioned below may all be logical nodes or functions that can be flexibly deployed in a communication network. In an example, the first network function may include a policy control function (PCF); the second network function may include a network exposure function (NEF) or an application function (AF); and the third network function may include a user plane function (UPF).

In an embodiment, the access network function node may be the access network device 120 described in FIG. 1, for example, may be a 2G base station, a 3G base station, a 4G base station, or an NG-RAN in a 5G system. The access network function node may be a radio access network (RAN) function node.

In an embodiment, the PDU set may include one or more PDUs. In the embodiments of the present disclosure, “multiple” refers to “two or more”.

The packet discarding here in step S21 may refer to packet discarding of one or more PDUs in the PDU set. The packet discarding in step S21 may also be packet discarding of a data flow and/or a data packet of any service.

For example, the packet discarding in the embodiment of the present disclosure refers to packet discarding of a predetermined service; for example, the predetermined service may be any one of a media service, an extended reality (XR) service, a cloud XR service, a game service, a cloud game service, a video-based robot service, and an unmanned aerial vehicle remote control service. The XR service may include an augmented reality (AR) service or a virtual reality (VR) service. For another example, the predetermined service may include an XRM service or an XRM service group.

In an embodiment, the packet discarding event information indicates a trigger event of packet discarding that achieves condition. In another embodiment, the packet discarding indication information indicates whether performing the packet discarding that achieves condition is needed, or whether performing the packet discarding that achieves condition is allowed.

In an embodiment, the packet discarding event information indicates a trigger event for a specific downlink service (for example, an XRM service) data flow that achieves condition.

In an embodiment, the packet discarding indication information indicates whether the downlink XRM service data flow that achieves condition needs to be discarded; or whether the downlink XRM service data flow that achieves condition is allowed to be discarded.

In an embodiment, the trigger event includes at least one of: a congestion parameter indicating a level of network congestion is greater than a congestion threshold; a packet error rate is greater than a packet error rate threshold; a delay is greater than a delay threshold; a user equipment (UE) status is a predetermined status; or a packet discarding filter of a data flow or the PDU set or a data packet is matched.

In an embodiment, the predetermined status of the UE may include: an overheating status, a battery status, a power mode status, a graphics processing unit (GPU) load balancing status.

Single-bit or multiple-bit information may be used to indicate that the UE is in a predetermined status. For example, a bit “00” indicates that the UE is in an overheating status, for another example, a bit “01” indicates that the UE is in a GPU load balancing status.

In an embodiment, the packet discarding event information may include one or more bits. For example, the packet discarding event information being “1” may indicate that the trigger event of the packet discarding that achieves condition is that the packet error rate is greater than the packet error rate threshold. For another example, the packet discarding event information being “00” indicates that no packet discarding that achieves condition needs to be performed. In an embodiment, the packet discarding indication information may include one or more bits. For another example, the packet discarding indication information being “11” indicates that performing the packet discarding that achieves condition is needed, and/or performing the packet discarding that achieves condition is allowed.

In the embodiment of the present disclosure, the first indication information is sent to the first network function through the access network function node, where the first indication information indicates at least one of: packet discarding event information of PDU set based QoS handling, and packet discarding indication information of PDU set based QoS handling. In this way, the first indication information may notify the first network function of a packet discarding trigger event of PDU set QoS handling and whether performing the packet discarding is needed or allowed, so that the first network function can determine whether to perform packet discarding; and in this way, occurrence of inaccurate charging results caused by intended packet discarding of the access network function node can be reduced.

An embodiment of the present disclosure provides an information processing method, performed by an access network function node, including: sending first indication information to a first network function when a trigger event occurs.

For example, the access network function node sends the first indication information to the first network function when determining that a packet discarding event of PDU set based QoS handling occurs, or when a packet error rate being greater than a packet error rate threshold is indicated.

An embodiment of the present disclosure provides an information processing method, performed by an access network function node, including: sending first indication information to a first network function in a session establishment procedure or a session modification procedure.

For example, the access network function node sends a session establishment request to the first network function, where the session establishment request carries the first indication information; or the access network function sends a session modification request to the first network function, where the session modification request carries the first indication information.

In an embodiment, the CP function includes, but is not limited to: an AMF and/or an SMF.

In some embodiments, sending the first indication information to the first network function through the CP function in step S21 includes: sending the first indication information to the first network function through the AMF and the SMF.

As shown in FIG. 3, an embodiment of the present disclosure provides an information processing method, performed by an access network function node, including step S31.

Step S31: sending first indication information to a first network function through an AMF and an SMF.

In some embodiments, sending the first indication information to the first network function through the AMF and the SMF includes: sending the first indication information to the AMF, where the first indication information is used to be sent to the SMF by the AMF, and is used by the SMF to send second indication information to the first network function, where the second indication information carries the first indication information; or, sending the first indication information to the AMF, where the first indication information is used by the AMF to send second indication information carrying the first indication information to the first network function upon receiving the first indication information.

According to an embodiment of the present disclosure, an information processing method is provided, performed by an access network function node, including: sending the first indication information to the AMF, where the first indication information is used to be sent to the SMF by the AMF, and is used by the SMF to send second indication information to the first network function, where the second indication information carries the first indication information; or, sending the first indication information to the AMF, where the first indication information is used by the AMF to send second indication information carrying the first indication information to the first network function upon receiving the first indication information.

In an embodiment, the first indication information is same as the second indication information. Content of the second indication information can be referred from related content of the first indication information.

For example, the access network function node sends the first indication information to the AMF; the AMF sends the first indication information to the SMF; and the SMF sends the first indication information to the PCF.

For example, the access network function node sends the first indication information to the AMF, and the AMF sends the first indication information to the PCF.

In another embodiment, the first indication information is different from the second indication information. For example, the first indication information includes packet discarding event information and/or packet discarding indication information, and the second indication information includes the first indication information and a measured report. For example, the second indication information includes the packet discarding event information and/or the packet discarding indication information, and also includes the measured report.

The measured report herein may include report information measured for any event of the UE; for example, the measured report may be a report for measuring at least one of network speed, network congestion, or packet error rate of the UE.

For example, the access network function node sends the first indication information to the AMF; the AMF sends the first indication information to the SMF; and the SMF determines, based on the first indication information, second indication information carrying the first indication information and the measured report, and sends the second indication information to the PCF.

For example, the access network function node sends the first indication information to the AMF; and the AMF determines, based on the first indication information, second indication information carrying the first indication information and the measured report, and sends the second indication information to the PCF.

In this way, in the embodiment of the present disclosure, the access network function node may send, through the control plane function, the first indication information used to indicate the packet discarding event information and/or the packet discarding indication information of the PDU set based QoS handling to the PCF in a core network, so that reporting based on the first indication information on the control plane can be implemented.

It should be noted that those skilled in the art may understand that the method provided in the embodiments of the present disclosure may be performed separately, or may be performed together with some methods in the embodiments of the present disclosure or some methods in related technologies.

The following information processing method is performed by the first network function, and is similar to the description of the information processing method performed by the access network function node; and for technical details not disclosed in the embodiment of the information processing method performed by the first network function, the description of the example of the information processing method performed by the access network function node can be referred to, and details will not be described herein.

As shown in FIG. 4, an embodiment of the present disclosure provides an information processing method, performed by a first network function, including step S41.

Step S41: receiving first indication information sent by an access network function node through a control plane (CP) function, where the first indication information indicates at least one of: packet discarding event information of packet data unit (PDU) set based quality of service (QoS) handling; or packet discarding indication information of PDU set based QoS handling.

In some embodiments of the present disclosure, the first network function may be the first network function in step S21. For example, the first network function node includes a PCF.

In some embodiments of the present disclosure, the packet discarding event information and the packet discarding indication information may be the packet discarding event information and the packet discarding indication information in step S21. For example, the packet discarding event information indicates a trigger event for packet discarding that achieves condition; and/or, the packet discarding indication information indicates whether performing the packet discarding that achieves condition is needed, or whether performing the packet discarding that achieves condition is allowed.

In some embodiments of the present disclosure, the trigger event may be the trigger event in the embodiments. An example of the trigger event includes at least one of: a congestion parameter indicating a level of network congestion is greater than a congestion threshold; a packet error rate is greater than a packet error rate threshold; a delay is greater than a delay threshold; a user equipment (UE) status is a predetermined status; or; a packet discarding filter of a data flow or the PDU set or a data packet is matched.

In some embodiments of the present disclosure, the CP function may be the CP function in the embodiments. For example, the CP function includes an AFM and/or an SMF.

In some embodiments, receiving the first indication information sent by the access network function node through the CP function in step S41 includes: receiving the first indication information sent by the access network function node through the AMF and the SMF.

An embodiment of the present disclosure provides an information processing method, performed by a first network function and including: receiving first indication information sent by an access network function node through an AMF and an SMF.

In some embodiments, receiving the first indication information sent by the access network function node through the AMF and the SMF includes: receiving second indication information carrying the first indication information sent by the SMF, where the first indication information is sent by the access network function node and is received by the AMF, and is sent to the SMF by the AMF; or, receiving second indication information carrying the first indication information sent by the AMF, where the first indication information is sent by the access network function node and is received by the AMF.

In an embodiment, the first indication information is the same as the second indication information.

In another embodiment, the first indication information is different from the second indication information. For example, the second indication information includes the first indication information and a measured report.

For details of the implementation, reference may be made to the description on the access network function node side, and details will not be repeated herein.

It should be noted that those skilled in the art may understand that the method provided in the embodiments of the present disclosure may be performed separately, or may be performed together with some methods in the embodiments of the present disclosure or some methods in related technologies.

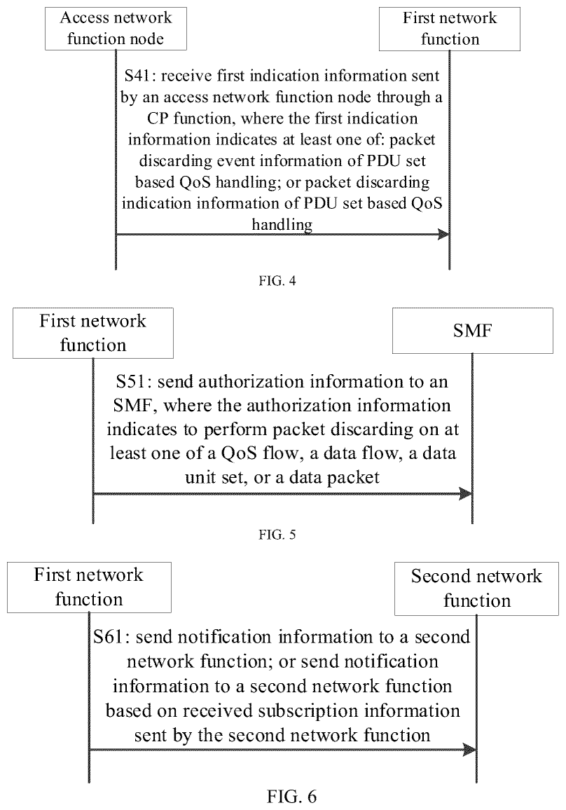

As shown in FIG. 5, an embodiment of the present disclosure provides an information processing method, performed by a first network function, including step S51.

Step S51: sending authorization information to an SMF, where the authorization information indicates to perform packet discarding on at least one of a QOS flow, a data flow, a data unit set, or a data packet. Where the authorization information is used by the SMF to send rule information to a third network function, and the rule information is used by the third network function to perform the packet discarding on at least one of the QoS flow, the data flow, the data unit set, or the data packet.

In an embodiment, the data unit set may include a PDU set. The packet discarding performed on the data unit set may be packet discarding performed on a PDU set, or a PDU in the PDU set.

In an embodiment, the third network function includes a UPF.

The authorization information herein indicates to perform the packet discarding on at least one of the QoS flow, the data flow, the data unit set, and the data packet of a predetermined service. The rule information is used by the third network function to perform packet discarding on at least one of the QoS flow, the data flow, the data unit set, and the data packet of the predetermined service. For example, the predetermined service may include an XRM service or an XRM service group.

The SMF herein may determine the rule information based on the authorization information. The rule information may include one or more of policy and charging control (PCC) rule information, QoS rule information, data flow filtering rule information, usage monitoring rule information, measurement rule information, and the like.

In this embodiment of the present disclosure, the authorization information may be sent to the SMF through the first network function, to authorize the SMF to perform packet discarding on at least one of the QoS flow, the data flow, the data unit set, or the data packet. Also, the SMF may determine the rule information and send the rule information to the third network function, so that the third network function may perform packet discarding on at least one of the QoS flow, the data flow, the data unit set, and the data packet of the predetermined service based on the rule information; in such way, the access network function node can notify the core network to perform the packet discarding.

In some embodiments, sending the authorization information to the SMF in step S51 includes: determining, based on the first indication information, that packet discarding needs to be performed, and sending the authorization information to the SMF.

An embodiment of the present disclosure provides an information processing method, performed by a first network function, including: determining, based on first indication information, that packet discarding needs to be performed, and sending authorization information to an SMF.

It is determined that the packet discarding needs to be performed if the packet discarding event information of the first indication information indicates a trigger event of packet discarding that achieves condition, and/or the packet discarding indication information indicates that performing packet discarding that achieves condition is needed, and/or the packet discarding indication information indicates that performing the packet discarding that achieves condition is allowed.

In this way, in this embodiment of the present disclosure, the first network function sends the authorization information to the SMF only when determining, based on the first indication information, that packet discarding needs to be performed; on one hand, signaling cost can be saved, and on the other hand, the third network function can accurately determine the packet discarding.

It should be noted that those skilled in the art may understand that the method provided in the embodiments of the present disclosure may be performed separately, or may be performed together with some methods in the embodiments of the present disclosure or some methods in related technologies.

As shown in FIG. 6, an embodiment of the present disclosure provides an information processing method, performed by a first network function, including step S61.

Step S61: sending notification information to a second network function; or sending notification information to a second network function based on received subscription information sent by the second network function. Where the notification information includes at least one of: a measured report; the packet discarding event information; or the packet discarding indication information.

In an embodiment, before step S61 is performed, the method includes: receiving the subscription information sent by the second network function. For example, the first network function receives the subscription information sent by the second network function, where the subscription information is used to subscribe to the notification information; and the first network function sends the notification information to the second network function based on the subscription information.

In an embodiment, the second network function includes a NEF or an AF. For example, when the second network function is the NEF, the first network function receives the subscription information sent by the NEF; and/or the first network function sends the notification information to the NEF. For example, when the second network function is the AF, the first network function receives the subscription information sent by the NEF, where the subscription information is sent by the AF to the NEF; and/or the first network function sends the notification information to the NEF, where the notification information is to be sent to the AF by the NEF.

In this embodiment of the present disclosure, the first network function may initiatively send the notification information to the second network function, to notify the second network function of a packet discarding related situation (for example, a packet discarding related measured report, packet discarding event information, and/or packet discarding indication information). Alternatively, the first network function may send the notification information to the second network function after receiving the subscription information of the second network function, to notify the second network function of related situations of packet discarding. In this way, sending the notification information to the second network function through multiple choices may be applicable to more application scenarios.

For details of the implementation, reference may be made to the description on the access network function node side, and details will not be repeated herein.

It should be noted that those skilled in the art may understand that the method provided in the embodiments of the present disclosure may be performed separately, or may be performed together with some methods in the embodiments of the present disclosure or some methods in related technologies.

The following information processing method is performed by the second network function, and is similar to the description of the information processing method performed by the access network function node and/or the first network function; and for technical details not disclosed in the embodiment of the information processing method performed by the second network function, the description of the example of the information processing method performed by the access network function node and/or the first network function can be referred to, and details will not be described herein.

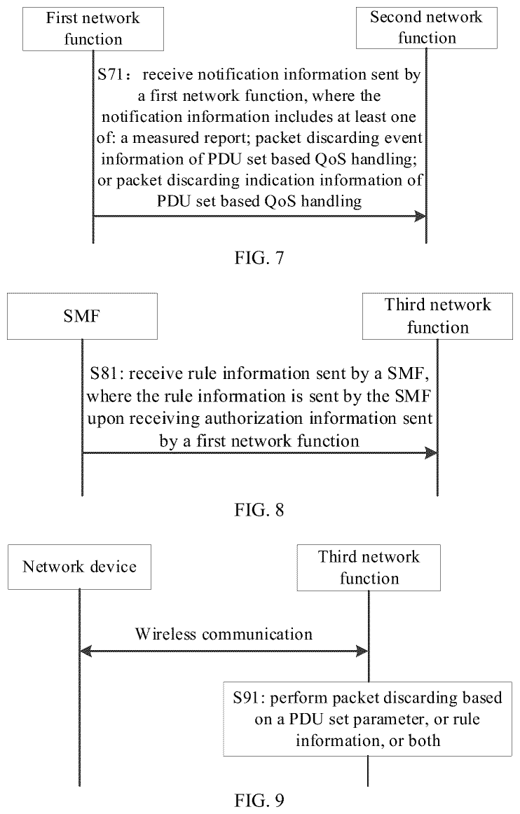

As shown in FIG. 7, an embodiment of the present disclosure provides an information processing method, performed by a second network function, including step S71.

Step S71: receiving notification information sent by a first network function, where the notification information includes at least one of: a measured report; packet discarding event information of PDU set based QoS handling; or packet discarding indication information of PDU set based QoS handling.

An embodiment of the present disclosure provides an information processing method, performed by a second network function, and including: sending subscription information to a first network function, where the subscription information is used for requesting notification information.

In some embodiments of the present disclosure, the first network function and the second network function are the first network function and the second network function in the embodiments, respectively. For example, the first network function includes a PCF, and the second network function includes a NEF or an AF.

In some embodiments of the present disclosure, the notification information and the subscription information may respectively be the notification information and the subscription information in the embodiments; and the packet discarding event information and the packet discarding indication information may respectively be the packet discarding event information and the packet discarding indication information in the embodiments.

For details of the implementation, reference may be made to the description on the access network function node side and/or the first network function side, and details will not be repeated herein.

It should be noted that those skilled in the art may understand that the method provided in the embodiments of the present disclosure may be performed separately, or may be performed together with some methods in the embodiments of the present disclosure or some methods in related technologies.

The following information processing method is performed by a third network function, and is similar to the description of the information processing method performed by the access network function node and/or the first network function and/or the second network function; and for technical details not disclosed in the embodiment of the information processing method performed by the third network function, the description of the example of the information processing method performed by the access network function node and/or the first network function and/or the second network function can be referred to, and details will not be described herein.

As shown in FIG. 8, an embodiment of the present disclosure provides an information processing method, performed by a third network function, including step S81.

Step S81: receiving rule information sent by a session management function (SMF), where the rule information is sent by the SMF upon receiving authorization information sent by a first network function. Where the authorization information indicates to perform packet discarding on at least one of a quality of service (QoS) flow, a data flow, a data unit set, and a data packet, and the rule information is used by the third network function to perform the packet discarding on at least one of the QoS flow, the data flow, the data unit set, and the data packet.

The authorization information herein is determined by the SMF based on the received authorization information sent by the first network function.

The authorization information herein is determined by the first network function based on the first indication information. In some embodiments of the present disclosure, the first indication information may be the first indication information in the embodiments.

In some embodiments of the present disclosure, the first network function and the third network function may be the first network function and the third network function in the embodiments, respectively. For example, the first network function includes a PCF, and the third network function includes a UPF.

In some embodiments of the present disclosure, the rule information may be the rule information in the embodiments. For example, the rule information may include one or more of PCC rule information, QoS rule information, data flow filtering rule information, usage monitoring rule information, or measurement rule information.

For details of the implementation, reference may be made to the description on the access network function node side and/or the first network function side, and details will not be repeated herein.

It should be noted that those skilled in the art may understand that the method provided in the embodiments of the present disclosure may be performed separately, or may be performed together with some methods in the embodiments of the present disclosure or some methods in related technologies.

As shown in FIG. 9, an embodiment of the present disclosure provides an information processing method, performed by a third network function, including step S91.

Step S91: performing packet discarding based on a PDU set parameter, or rule information, or both.

In some embodiments, performing the packet discarding includes at least one of: performing packet discarding on an entire data packet of a PDU set or a part of the data packet of the PDU set based on a dependency relationship or an importance relationship of the PDU set; performing packet discarding within a packet discarding window time; performing packet discarding based on different data flow priorities; or performing packet discarding on a PDU set with a specific dependency relationship or a PDU set with a specific importance relationship.

The PDU set parameter herein includes at least one of: a PDU set delay budget, a delay budget of PDUs in the PDU set, an error rate of packet in the PDU set, a dependent packet in the PDU set, an important packet in the PDU set, a priority of the PDU set, a PDU set with a specific dependency relationship, or a PDU set with a specific importance relationship.

An embodiment of the present disclosure provides an information processing method, performed by a third network function, including at least one of: performing packet discarding on an entire data packet of a PDU set or a part of the data packet of the PDU set based on a dependency relationship or an importance relationship of the PDU set; performing packet discarding within a packet discarding window time; performing packet discarding based on different data flow priorities; or performing packet discarding on a PDU set with a specific dependency relationship or a PDU set with a specific importance relationship.

In some embodiments, performing the packet discarding includes at least one of: performing packet discarding on a PDU set based on an exceeded PDU set delay budget (PSDB); performing packet discarding on a PDU set based on an exceeded PDU set error rate; performing packet discarding on a PDU set based on delivery failure of a dependent PDU set; performing packet discarding on data packet of a PDU set based on delivery failure of an important PDU set; performing packet discarding on a PDU set based on an exceeded packet delay budget (PSDB) of the PDU set; performing packet discarding on a PDU set based on an exceeded packet error rate of the PDU set; performing packet discarding on data packet of a PDU set based on delivery failure of a dependent packet in the PDU set; or performing packet discarding on data packet of a PDU set based on delivery failure of an important packet in the PDU set.

An embodiment of the present disclosure provides an information processing method, performed by a third network function, including at least one of: performing packet discarding on a PDU set based on an exceeded PDU set delay budget (PSDB); performing packet discarding on a PDU set based on an exceeded PDU set error rate; performing packet discarding on a PDU set based on delivery failure of a dependent PDU set; performing packet discarding on data packet of a PDU set based on delivery failure of an important PDU set; performing packet discarding on a PDU set based on an exceeded packet delay budget (PSDB) of the PDU set; performing packet discarding on a PDU set based on an exceeded packet error rate of the PDU set; performing packet discarding on data packet of a PDU set based on delivery failure of a dependent packet in the PDU set; or performing packet discarding on data packet of a PDU set based on delivery failure of an important packet in the PDU set.

The third network function herein may perform partial or entire packet discarding for at least one of a data flow, a PDU set, and a data packet of a predetermined service.

The dependent data packet herein may also be a data packet of a dependency relationship.

The exceeded PSDB herein refers that the PSDB exceeds the PSDB threshold; and the exceeded error rate refers that the error rate exceeds the error rate threshold.

For example, for a video call service, the third network device may include an audio data flow and a video data flow that is selectively discarded.

In the embodiments of the present disclosure, the packet discarding may be performed in multiple manners, which is hence applicable to more application scenarios.

In another embodiment, if the access network device does not send the first indication information to the first network function or the third network function does not receive the rule information, the third network function may determine, based on at least one of an operator policy, local configuration, and subscription information, whether packet discarding of the QoS processing data packet of the PDU set and/or performing a corresponding packet discarding is supported.

For details of the implementation, reference may be made to the description on the access network function node side and/or the first network function side, and details will not be repeated herein.

It should be noted that those skilled in the art may understand that the method provided in the embodiments of the present disclosure may be performed separately, or may be performed together with some methods in the embodiments of the present disclosure or some methods in related technologies.

To further describe any embodiment of the present disclosure, several specific examples are provided below.

### Example 1

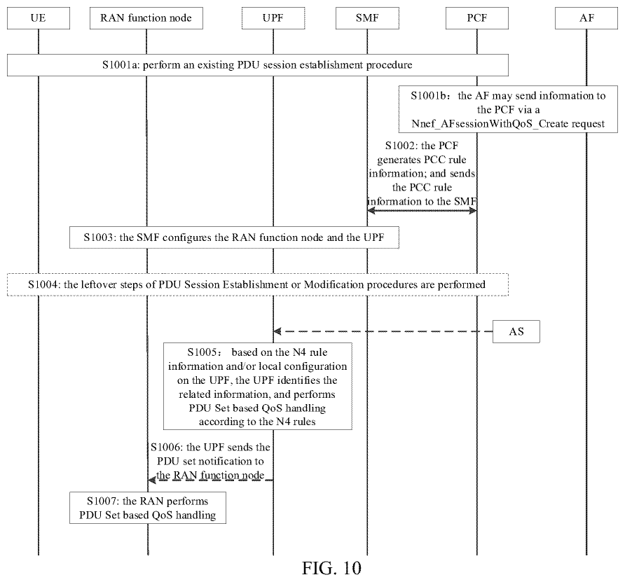

In some application scenarios, PDU set based policy and charging control may occur during a PDU session establishment or modification procedure. As shown in FIG. 10, an embodiment of the present disclosure provides an information processing method, performed by a communication device, where the communication device includes a UE, a RAN function node, an AMF, an SMF, a PCF, a UPF, and an AF.

Step S1001a: an existing PDU session establishment procedure is performed.

Step S1001b: the AF may send information to the PCF via a Nnef_AFsessionWithQoS_Create request.

Where the information may be QoS parameters for each PDU Set within the QoS flow and/or parameters on frame identification. The AF may also provide this information to 5G prior to PDU session establishment.

The QoS parameters for each PDU Set within the QoS flow includes at least one of: PDU Set handling indication, where the PDU Set handling indication indicates whether PDU Set based handling should be activated to a data flow; a parameter indicating whether all PDUs are needed for the usage of PDU Set by application layer; PDU Set Delay Budget (PSDB); or PDU Set Error Rate.

The parameters on frame identification include burst periodicity.

Step S1002: the PCF generates PCC rule information; and sends the PCC rule information to the SMF. Where the PCC rule information may include QoS parameters. The PCF and/or SMF generates the rule information, and performs transferring optimization or selective flow control (for example, initiative packet discarding triggered by an event such as congestion) on downlink XRM data flows; where a prediction result of UPF transferring may be a network analysis result (network congestion) of the NWDAF (Network Data Analytics Function), or an event notification result (for example, network congestion) reported by the RAN function node, and the PCF determines to generate the PCC rule information by considering the prediction result.

The PDU Set related QoS parameters are new QoS parameters for PDU Set based QoS handling in the 5G system, and the QoS parameters include at least one of: PDU Set Delay Budget (PSDB); PDU Set Error Rate; a parameter indicating whether all PDUs are needed for the usage of PDU Set by application layer; a parameter indicating whether to discard a PDU Set in case PSDB is exceeded; or PDU Set priority or PDU priority. The “PDU Set priority” be the same for all PDU Sets (i.e. same as existing QoS Flow Priority), or it be different for each PDU Set (i.e. same as “PDU Set importance”).

This step is done in PDU Session Establishment procedure, or in PDU Session Modification procedure. (PDU Session Establishment procedure, PDU Session Modification procedure).

If this step is triggered by Session Modification procedure, the PCF generates the PCC rule information by considering the information provided by the AF.

Step S1003: the SMF configures the RAN function node and the UPF.

The SMF generates QoS profiles and N4 rule information based on the PCC rule information from the PCF. The SMF sends the N4 rule information to the UPF and sends the QoS profiles to the RAN function node via the AMF.

This step is done via steps 8-15 in PDU Session Establishment procedure, or steps 2-7 in PDU Session Modification procedure.

Step S1004: the leftover steps of PDU Session Establishment or Modification procedures are performed.

Step S1005: based on the N4 rule information and/or local configuration on the UPF, the UPF identifies the related information, and performs PDU Set based QoS handling according to the N4 rules. Where related information on UPF identification includes at least one of: rule information generated and delivered by the UPF based on a previously installed PCF and/or SMF; transfer optimization and/or selective packet discarding (for example, initiative and selective packet discarding triggered by an event such as congestion) are performed on downlink XRM data; a granularity for optimization may include: a data flow, a PDU set, or a data packet; and/or an event for optimization may include: a predetermined time window, a predetermined traffic threshold, or a predetermined packet discarding ratio (a packet error rate threshold).

The UPF identifies the PDUs belong to a PDU Set and the following information for each PDU Set: PDU Set Sequence number (SN) (the QoS Flow is identified using QoS Flow identifier and each PDU Set within the QOS Flow is identified using PDU Set SN, each QoS Flow can be used to deliver one or more PDU Set); Start/End PDU of the PDU Set; PDU SN within a PDU Set; and number of PDUs within a PDU Set.

Information for inter-PDU Set handling includes at least one of: PDU Set importance; or PDU Set dependency.

The UPF identifies the related information via the methods/mechanisms described, as follows in options 1-5.

Option 1: by matching RTP (Real-Time Transport Protocol)/SRTP (Secure Real-Time Transport Protocol) header and payload.

Option 2: new RTP extension header.

Option 3: by information provided by the AS in N6 encapsulation header e.g. GTP-U (GPRS Tunneling Protocol-User Plane).

Option 4: by detection based on traffic characteristics.

Option 5: by non-standardized mechanisms UPF implementation.

Step S1006: the UPF sends the PDU set notification to the RAN function node. Where the UPF provides the PDU Set related information (listed in the related information in step S1205) to the RAN function node.

For PDU Set importance relationship, optionally: Option 1: the UPF classifies the DL (downlink) traffics into different QoS Flows based on PDU Set importance relationship; Option 2: the UPF classifies the DL traffics into different sub-QoS Flows based on PDU Set importance relationship; and Option 3: the UPF adds the PDU Set importance relationship into GTP-U header.

For other PDU Set related information in step S1005, the UPF adds them into GTP-U Header.

Step S1007: the ran performs PDU set based QoS handling.
where based on the PDU Set related information received in Step S1206, the RAN performs PDU Set based QoS handling.

If monitoring and reporting of the prediction event are performed for the RAN function node, in a process of performing QoS handling (PDU set based QoS handling) of the PDU set by the RAN function node, when a packet discarding trigger event (for example, a congestion level is greater than a threshold, a packet error rate is greater than a threshold, a delay is greater than a threshold, and a status-related requirement of the UE) is detected, packet discarding event information and/or post-packet discarding indication information of a QoS handling data packet of the PDU set are reported to a core network (CN).

The CN-CP function determines, based on received packet discarding event information of PDU set based QoS handling and/or packet discarding indication information, whether to perform packet discarding (for example, active packet discarding) on the PDU Set based QoS handling packet.

For example, the packet discarding event information of PDU set based QoS handling indicates that a downlink XRM service data flow meets a trigger event (trigger/events of XRM service downlink traffic eligible discarding), and the trigger event includes network congestion (a congestion parameter indicating network congestion level is greater than a congestion threshold), a packet error rate is greater than a packet error rate threshold, a delay is greater than a delay threshold, and a UE status related requirement. The UE status related requirements include overheating, battery, power mode status, and/or GPU load balancing status requirements.

For example, the packet discarding indication information of PDU set based QoS handling indicates whether the downlink XRM service data flow that achieves condition needs to be discarded; or whether the downlink XRM service data flow that achieves condition is allowed to be discarded.

In this embodiment of the present disclosure, the PDU parameter and/or QoS parameter related information may be obtained through the core network device, and the rule information (for example, PCC rule information) may be generated based on the related information; which is beneficial to determining appropriate packet discarding by the control plane function in the core network device. Also, the QoS parameter of the generated rule information may be updated in time, to obtain the rule information matching a current network environment.

It should be noted that those skilled in the art may understand that the method provided in the embodiments of the present disclosure may be performed separately, or may be performed together with some methods in the embodiments of the present disclosure or some methods in related technologies.

### Example 2

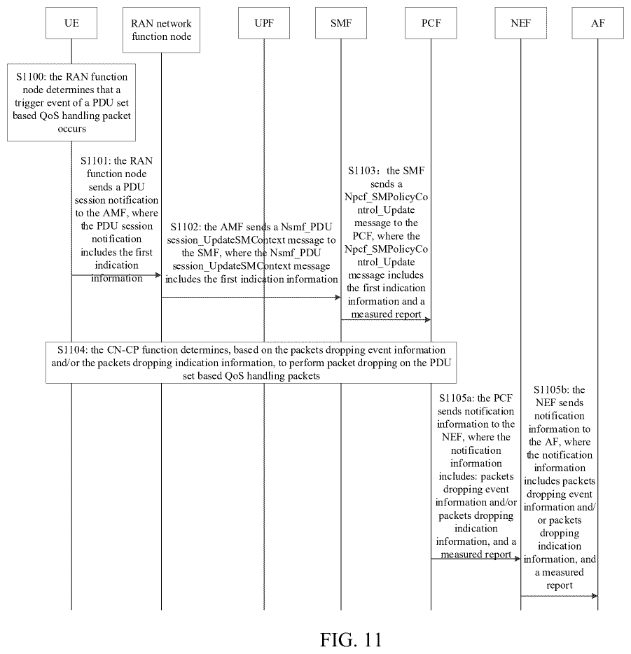

As shown in FIG. 11, an embodiment of the present disclosure provides an information processing method, performed by a communication device, where the communication device includes a RAN function node, an AMF, a UPF, an SMF, a PCF, a NEF, and an AF.

Step S1100: the RAN function node determines that a trigger event of a PDU set based QOS handling packet occurs.

Step S1101: the RAN function node sends a PDU session notification to the AMF, where the PDU session notification includes the first indication information. Where the PDU session message may be notification control in the NG message; the first indication information may be the first indication information in the embodiment; and the first indication information includes packet discarding event information and/or packet discarding indication information.

Step S1102: the AMF sends a Nsmf_PDU session_UpdateSMContext message to the SMF, where the Nsmf_PDU session_UpdateSMContext message includes the first indication information.

Step S1103: the SMF sends a Npcf_SMPolicyControl_Update message to the PCF, where the Npcf_SMPolicyControl_Update message includes the first indication information and a measured report.

Step S1104: the CN-CP function determines, based on the packet discarding event information and/or the packet discarding indication information, to perform packet discarding on the PDU set based QoS handling packet. Where the PCF initiates a PDU session modification procedure to notify the authorized SMF to perform packet discarding on the predetermined QoS flow and/or service data flow and/or data unit set and/or data packet. The SMF configures the UPF based on the updated rule information; and the UPF performs packet discarding on the predetermined QoS flow and/or the service data flow and/or the data unit set and/or the data packet. Specifically, the UPF may perform packet discarding with reference to the PDU set parameter and the rule information. For example, packet discarding is performed based on a dependency relationship or an importance relationship of a PDU set (for example, a data packet of the PDU set is completely or partially discarded); a packet discarding is performed based on a packet discarding window time; and a packet discarding is performed on data flows of a specific dependency relationship or importance relationship based on priorities of different data flows (for example, in an audio-video telephone, an audio data flow is reserved and a video flow data flow is selectively discarded).

In an embodiment, the packet discarding window time may be a predetermined time window.

A reason for performing packet discarding (discarding the PDU set or the PDU in the PDU set) may include at least one of: for the PDU set discarding may be at least one of: performing packet discarding on a PDU set based on an exceeded PDU set delay budget (PSDB); performing packet discarding on a PDU set based on an exceeded PDU set error rate; performing packet discarding on a PDU set based on delivery failure of a dependent PDU set; performing packet discarding on data packet of a PDU set based on delivery failure of an important PDU set; and for the PDU discarding in the PDU set may include at least one of: performing packet discarding on a PDU set based on an exceeded packet delay budget (PSDB) of the PDU set; performing packet discarding on a PDU set based on an exceeded packet error rate of the PDU set; performing packet discarding on data packet of a PDU set based on delivery failure of a dependent packet in the PDU set; or performing packet discarding on data packet of a PDU set based on delivery failure of an important packet in the PDU set.

Step S1105a: the PCF sends notification information to the NEF, where the notification information includes: packet discarding event information and/or packet discarding indication information, and a measured report.

Where the notification information may be Npcf_Policy Authorization_Notify.

Step S1105b: the NEF sends notification information to the AF, where the notification information includes packet discarding event information and/or packet discarding indication information, and a measured report.

The notification information herein may be Nnef_AFsessionWithQoS_Notify.

In the embodiments of the present disclosure, the reporting based on the packet discarding event information and/or the packet discarding indication information on the control plane may be implemented through the CP function, thereby facilitating the CN-CP function (for example, the UPF) to accurately determine whether performing packet discarding is needed; in this way, the occurrence of inaccurate charging result caused by initiative packet discarding of the access network function node is reduced.

It should be noted that those skilled in the art may understand that the method provided in the embodiments of the present disclosure may be performed separately, or may be performed together with some methods in the embodiments of the present disclosure or some methods in related technologies.

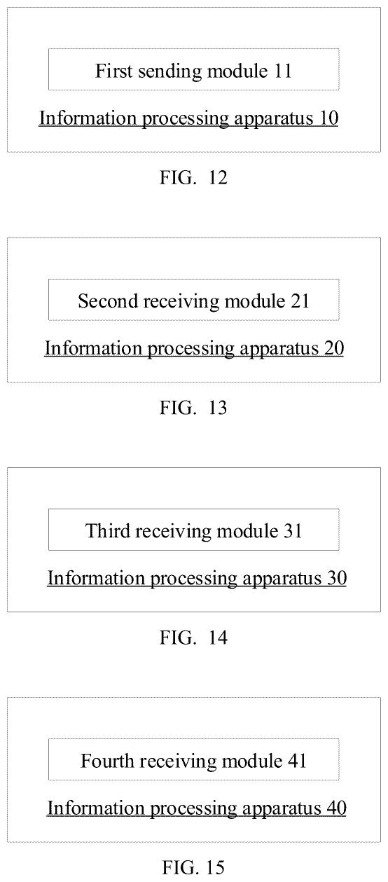

As shown in FIG. 12, an embodiment of the present disclosure provides an information processing apparatus 10, including a first sending module 11.

The first sending module 11 is configured to send first indication information to a first network function through a control plane (CP) function, where the first indication information indicates at least one of: packet discarding event information of PDU set based QoS handling; or packet discarding indication information of PDU set based QoS handling.

The information processing apparatus provided in the embodiments of the present disclosure may include an access network function node.

In some embodiments, the packet discarding event information indicates a trigger event of packet discarding that achieves condition; and/or, the packet discarding indication information indicates whether performing the packet discarding that achieves condition is needed, or whether performing the packet discarding that achieves condition is allowed.

In some embodiments, the trigger event includes at least one of: a congestion parameter indicating a level of network congestion is greater than a congestion threshold; a packet error rate is greater than a packet error rate threshold; a delay is greater than a delay threshold; a user equipment (UE) status is a predetermined status; or a packet discarding filter of a data flow or the PDU set or a data packet is matched.

An embodiment of the present disclosure provides an information processing apparatus, including: a first sending module 11, configured to send first indication information to a first network function through an AMF and an SMF.

An embodiment of the present disclosure provides an information processing apparatus, including: a first sending module 11, configured to send the first indication information to the AMF, where the first indication information is used to be sent to the SMF by the AMF, and is used by the SMF to send second indication information to the first network function, where the second indication information carries the first indication information.

An embodiment of the present disclosure provides an information processing apparatus, including: a first sending module 11, configured to send the first indication information to the AMF, where the first indication information is used by the AMF to send second indication information carrying the first indication information to the first network function upon receiving the first indication information.

In some embodiments, the second indication information further includes a measured report.

In some embodiments, the first network function includes a PCF.

An embodiment of the present disclosure provides an information processing device, including a first receiving module.

As shown in FIG. 13, an embodiment of the present disclosure provides an information processing apparatus 20, performed by a first network function, including a second receiving module 21.

The second receiving module 21 is configured to receive first indication information sent by an access network function node through a control plane (CP) function, where the first indication information indicates at least one of: packet discarding event information of PDU set based QoS handling; or packet discarding indication information of PDU set based QoS handling.

The information processing apparatus provided in the embodiments of the present disclosure may be a first network function.

In some embodiments, the packet discarding event information indicates a trigger event of packet discarding that achieves condition; and/or, the packet discarding indication information indicates whether performing the packet discarding that achieves condition is needed, or whether performing the packet discarding that achieves condition is allowed.

In some embodiments, the trigger event includes at least one of: a congestion parameter indicating a level of network congestion is greater than a congestion threshold; a packet error rate is greater than a packet error rate threshold; a latency is greater than a latency threshold; a user equipment (UE) status is a predetermined status; or a packet discarding filter of a data flow or the PDU set or a data packet is matched.

An embodiment of the present disclosure provides an information processing apparatus, including: a second receiving module 21, configured to receive first indication information sent by an access network function node through an AMF and an SMF.

An embodiment of the present disclosure provides an information processing apparatus, including: a second receiving module 21, configured to receive second indication information carrying first indication information sent by an SMF, where the first indication information is received by an AMF from an access network function node and sent to the SMF.

An embodiment of the present disclosure provides an information processing apparatus, including: a second receiving module 21, configured to receive second indication information carrying first indication information sent by an AMF, where the first indication information is received by the AMF from an access network function node.

In some embodiments, the second indication information further includes a measured report.

In some embodiments, the first network function includes a PCF.

An embodiment of the present disclosure provides an information processing apparatus, including a second sending module, configured to send authorization information to an SMF, where the authorization information indicates to perform packet discarding on at least one of a QoS flow, a data flow, a data unit set, or a data packet. Where the authorization information is used by the SMF to send rule information to a third network function, and the rule information is used by the third network function to perform the packet discarding on at least one of the QoS flow, the QoS flow, the data flow, the data unit set, or the data packet.

An embodiment of the present disclosure provides an information processing apparatus, including the second sending module, configured to determine, based on the first indication information, that packet discarding needs to be performed, and send the authorization information to the SMF.

An embodiment of the present disclosure provides an information processing apparatus, including a second sending module, configured to send notification information to the second network function, where the notification information includes at least one of: a measured report, the packet discarding event information, and the packet discarding indication information.

An embodiment of the present disclosure provides an information processing apparatus, including: sending notification information to the second network function based on the received subscription information sent by the second network function, where the notification information includes at least one of: a measured report, the packet discarding event information, and the packet discarding indication information.

In some embodiments, the second network function includes a NEF or an AF.

As shown in FIG. 14, an embodiment of the present disclosure provides an information processing apparatus 30, including a third receiving module 31.

The third receiving module 31 is configured to receive notification information sent by a first network function, where the notification information includes at least one of: a measured report; packet discarding event information of PDU set based QoS handling; or packet discarding indication information of PDU set based QoS handling.

The information processing apparatus provided by the embodiment of the present disclosure may be a second network function.

An embodiment of the present disclosure provides an information processing apparatus, including: a third sending module, configured to send subscription information to a first network function, where the subscription information is used to request notification information.

In some embodiments, the second network function includes a NEF or an AF.

As shown in FIG. 15, an embodiment of the present disclosure provides an information processing apparatus 40, including a fourth receiving module 41.

The fourth receiving module 41 is configured to receive rule information sent by a session management function (SMF), where the rule information is sent by the SMF upon receiving authorization information sent by a first network function. Where the authorization information indicates to perform packet discarding on at least one of a quality of service (QoS) flow, a data flow, a data unit set, and a data packet, and the rule information is used by the third network function to perform the packet discarding on at least one of the QoS flow, the data flow, the data unit set, and the data packet.

The information processing apparatus provided by the embodiment of the present disclosure may be a third network function.

An embodiment of the present disclosure provides an information processing apparatus, including: a processing module, configured to perform packet discarding based on a PDU set parameter and/or rule information.

An embodiment of the present disclosure provides an information processing apparatus, including: a processing module, configured to perform at least one of: performing packet discarding on an entire data packet of a PDU set or a part of the data packet of the PDU set based on a dependency relationship or an importance relationship of the PDU set; performing packet discarding within a packet discarding window time; performing packet discarding based on different data flow priorities; or performing packet discarding on a PDU set with a specific dependency relationship or a PDU set with a specific importance relationship.

An embodiment of the present disclosure provides an information processing apparatus, including: a processing module, configured to perform at least one of: performing packet discarding on a PDU set based on an exceeded PDU set delay budget (PSDB); performing packet discarding on a PDU set based on an exceeded PDU set error rate; performing packet discarding on a PDU set based on delivery failure of a dependent PDU set; performing packet discarding on data packet of a PDU set based on delivery failure of an important PDU set; performing packet discarding on a PDU set based on an exceeded packet delay budget (PSDB) of the PDU set; performing packet discarding on a PDU set based on an exceeded packet error rate of the PDU set; performing packet discarding on data packet of a PDU set based on delivery failure of a dependent packet in the PDU set; or performing packet discarding on data packet of a PDU set based on delivery failure of an important packet in the PDU set.

In some embodiments, the third network function includes a UPF.

It should be noted that those skilled in the art may understand that the apparatus provided in the embodiments of the present disclosure may be performed separately, or may be performed together with some apparatuses in the embodiments of the present disclosure or some apparatuses in related technologies.

Regarding the apparatus in the embodiments, a specific manner for each module to perform an operation has been described in detail in the embodiments related to the method, and will not be repeated in detail herein.

An embodiment of the present disclosure provides an information processing system, including: an access network function node, a first network function, a session management function (SMF), and a third network function. Where: the access network function node is configured to send first indication information to the first network function through a CP function, where the first indication information indicates at least one of: packet discarding event information of PDU set based QoS handling; or packet discarding indication information of PDU set based QoS handling; the first network function is configured to determine, based on the first indication information, that packet discarding needs to be performed, and send authorization information to the SMF, where the authorization information indicates to perform packet discarding on at least one of a QoS flow, a data flow, a data unit set, or a data packet; the SMF is configured to send rule information to the third network function based on the received authorization information, where the rule information is used by the third network function to perform the packet discarding on at least one of the QoS flow, the data flow, the data unit set, or the data packet; and the third network function is configured to perform packet discarding based on a packet data unit (PDU) set parameter, or the rule information, or both.

An embodiment of the present disclosure provides an information processing system, including: a first network function and a second network function. Where the first network function is configured to send notification information to the second network function, where the notification information includes at least one of: a measured report, the packet discarding event information, and the packet discarding indication information; or, the first network function is configured to send notification information to the second network function based on received subscription information sent by the second network function.

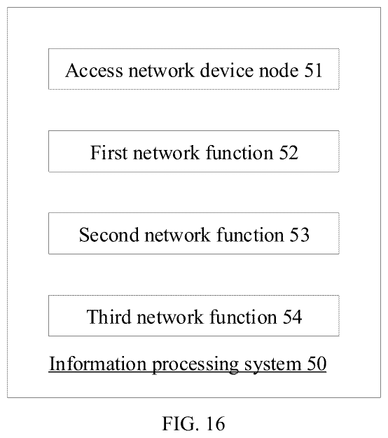

As shown in FIG. 16, an embodiment of the present disclosure provides an information processing system 50, including: an access network function node 51, a first network function 52, a second network function 53, and a third network function 54.

The access network function node 51 is configured to perform the information processing method applied to any embodiment in the access network function node. The first network function 52 is configured to perform the information processing method applied to any embodiment in the first network function. The second network function 53 is configured to perform the information processing method applied to any embodiment in the second network function. The third network function 54 is configured to perform the information processing method applied to any embodiment in the third network function.

Regarding the apparatus in the embodiments, a specific manner for each module to perform an operation has been described in detail in the embodiments related to the method, and will not be repeated in detail herein.

An embodiment of the present disclosure provides a communication device, including: a processor; and a memory for storing a processor-executable instruction; where the processor is configured to: execute the executable instruction to implement the information processing method according to any embodiment of the present disclosure.

In an embodiment, the communication device may include, but is not limited to, at least one of: a first network function, a second network function, and a third network function. The first network function may be a PCF; the second network function may be a NEF and an AF; and the third network function may be a UPF.

The processor may include various types of storage media, the storage media are non-transitory computer storage media, and can continue to memorize information stored on the storage media after the user equipment is powered off.

The processor may be connected to the memory by using a bus or the like, and is configured to read an executable program stored in the memory, for example, at least one of the methods shown in FIG. 2 to FIG. 11.

An embodiment of the present disclosure further provides a computer storage medium is provided, where the computer storage medium stores a computer-executable program, and when the executable program is executed by a processor, the information processing method of any embodiment of the present disclosure is implemented. For example, at least one of the methods shown in FIGS. 2 to 11.

Regarding the apparatus or the storage medium in the embodiments, a specific manner for each module to perform an operation has been described in detail in the embodiments related to the method, and will not be repeated in detail herein.

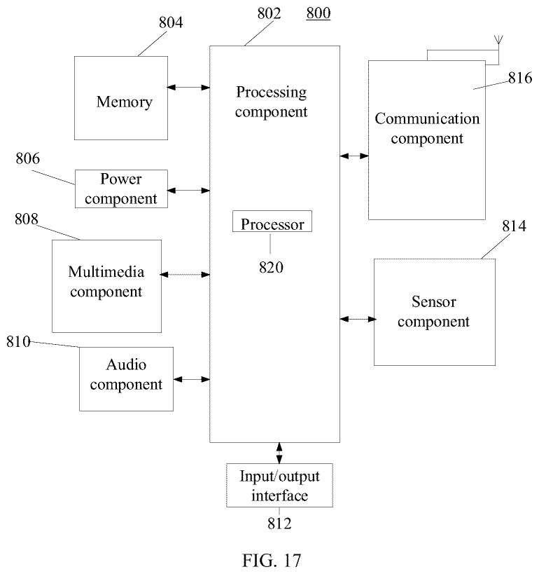

FIG. 17 is a block diagram of a user equipment (UE) 800 according to an example embodiment. For example, the UE 800 may be a mobile phone, a computer, a digital broadcast UE, a messaging device, a game console, a tablet device, a medical device, a fitness device, a personal digital assistant, or the like.

Referring to FIG. 17, the UE 800 may include one or more of: a processing component 802, a memory 804, a power component 806, a multimedia component 808, an audio component 810, an input/output (I/O) interface 812, a sensor component 814, and a communication component 816.

The processing component 802 typically controls overall operations of the UE 800, such as operations associated with display, telephone calls, data communications, camera operations, and recording operations. The processing component 802 may include one or more processors 820 to execute instructions to perform all or part of the steps of any of the methods. In addition, the processing component 802 may include one or more modules to facilitate interaction between the processing component 802 and other components. For example, the processing component 802 may include a multimedia module to facilitate interaction between the multimedia component 808 and the processing component 802.

The memory 804 is configured to store various types of data to support operations at the UE 800. Examples of such data include instructions for any application or method operating on the UE 800, contact data, phonebook data, messages, pictures, videos, and the like. The memory 804 may be implemented by any type of volatile or non-volatile storage device or a combination thereof, such as static random access memory (SRAM), electrically erasable programmable read-only memory (EEPROM), erasable programmable read-only memory (EPROM), programmable read-only memory (PROM), read-only memory (ROM), magnetic memory, flash memory, magnetic or optical disks.

The power component 806 provides power for various components of the UE 800. The power component 806 may include a power management system, one or more power sources, and other components associated with generating, managing, and distributing power for the UE 800.

The multimedia component 808 includes a screen providing an output interface between the UE 800 and the user. In some embodiments, the screen may include a liquid crystal display (LCD) and a touch panel (TP). If the screen includes a touch panel, the screen may be implemented as a touch screen to receive input signals from a user. The touch panel includes one or more touch sensors to sense touches, swipes, and gestures on the touch panel. The touch sensor may not only sense a boundary of a touch or slide action, but also detect a duration and pressure associated with the touch or slide operation. In some embodiments, the multimedia component 808 includes a front camera and/or a rear camera. When the UE 800 is in an operation mode, such as a photographing mode or a video mode, the front camera and/or the rear camera may receive external multimedia data. Each of the front camera and the rear camera may be a fixed optical lens system or have focal length and optical zoom capability.

The audio component 810 is configured to output and/or input audio signals. For example, the audio component 810 includes a microphone (MIC) configured to receive an external audio signal when the UE 800 is in an operation mode, such as a call mode, a recording mode, and a voice recognition mode. The received audio signal may be further stored in the memory 804 or transmitted via the communication component 816. In some embodiments, the audio component 810 further includes a speaker configured to output an audio signal.

The I/O interface 812 provides an interface between the processing component 802 and peripheral interface modules, which may be keyboards, click wheels, buttons, etc. These buttons may include, but are not limited to, home buttons, volume buttons, start buttons, and lock buttons.

The sensor component 814 includes one or more sensors for providing status assessments of various aspects of the UE 800. For example, the sensor component 814 may detect an open/closed state of the UE 800, relative positioning of components, such as a display and a keypad of the UE 800, a change in position of the UE 800 or a component of the UE 800, a presence or absence of user contact with the UE 800, an orientation or acceleration/deceleration of the UE 800, and a change in temperature of the UE 800. The sensor component 814 may include a proximity sensor configured to detect the presence of nearby objects without requiring any physical contact. The sensor component 814 may also include a light sensor, such as a CMOS or CCD image sensor, for use in imaging applications. In some embodiments, the sensor component 814 may further include an acceleration sensor, a gyroscope sensor, a magnetic sensor, a pressure sensor, or a temperature sensor.

The communication component 816 is configured to facilitate wired or wireless communication between the UE 800 and other devices. The UE 800 may access a wireless network based on a communication standard, such as WiFi, 4G, or 5G, or a combination thereof. In an example embodiment, the communication component 816 receives a broadcast signal or broadcast related information from an external broadcast management system via a broadcast channel. In an example embodiment, the communication component 816 further includes a near field communication (NFC) module to facilitate short-range communication. For example, the NFC module may be implemented based on radio frequency identification (RFID) technology, infrared data association (IrDA) technology, ultra-wideband (UWB) technology, Bluetooth (BT) technology, and other technologies.

In an example embodiment, the UE 800 may be implemented by one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components, and is configured to perform any of the methods.

In an example embodiment, there is further provided a non-transitory computer-readable storage medium including an instruction, such as a memory 804 including the instruction, where the instruction is executable by a processor 820 of the UE 800 to perform any of the methods. For example, the non-transitory computer-readable storage medium may be a ROM (read-only memory), a RAM (random access memory), CD-ROM (compact disc read-only memory), magnetic tape, floppy disk, optical data storage device, or the like.

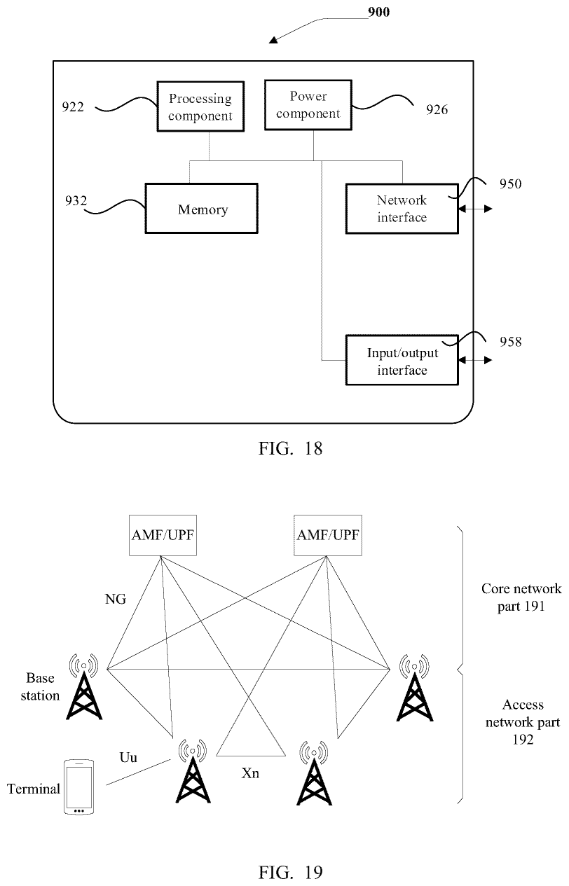

As shown in FIG. 18, an embodiment of the present disclosure shows a structure of a base station. For example, the base station 900 may be provided as a network-side device. Referring to FIG. 18, the base station 900 includes a processing component 922, which further includes one or more processors, and a memory resource represented by a memory 932 for storing instructions executable by the processing component 922, such as an application program. The application program stored in the memory 932 may include one or more modules each corresponding to a set of instructions. In addition, the processing component 922 is configured to execute instructions to perform any of the methods applied to the base station.

The base station 900 may also include a power component 926 configured to perform power management of the base station 900, a wired or wireless network interface 950 configured to connect the base station 900 to a network, and an input/output (I/O) interface 958. The base station 900 may operate based on an operating system stored in memory 932, such as Windows Server™, Mac OS X™, Unix™, Linux™, FreeBSD™, or the like.

As shown in FIG. 19, an embodiment of the present disclosure shows a network architecture of a 5G system, including a core network part 191 and an access network part 192. The core network part includes a core network device, and the core network device mainly includes communication nodes such as an Access and Mobility Management Function (AMF), a User Plane Function (UPF), a Network Exposure Function (NEF), a User Data Repository (UDR), and a Session Management Function (SMF). The access network part includes a base station. The AMF is mainly responsible for various functions related to registration management, connection management, access management, mobility management, and security and access management and authorization. The UPF is mainly responsible for various related functions such as a data plane anchor, a PDU session point connected to a data network, packet routing and forwarding, traffic usage reporting, and lawful interception. The NEF is mainly responsible for providing a security path to expose services and capabilities of the 3GPP network function to the AF and providing a security path to enable the AF to provide information to the 3GPP network function. The UDR is mainly responsible for storing important process data during wireless communication. The SMF is mainly responsible for various functions related to session management, charging and QoS policy control, lawful interception, charging data collection, downlink data notification, and the like.

Other embodiments of the present disclosure will easily occur to those skilled in the art after considering the specification and practicing the present disclosure herein. The present disclosure is intended to cover any variations, uses or adaptations of the present disclosure, which follow the general principles of the present disclosure and include common sense or common technical means in this technical field that are not disclosed in the present disclosure. The specification and examples are to be regarded as examples only, with the true scope and spirit of the present disclosure being indicated by the following claims.

It should be understood that the present disclosure is not limited to the precise structures described herein and shown in the accompanying drawings, and various modifications and changes may be made without departing from the scope thereof. The scope of the present disclosure is limited only by the appended claims.

1. An information processing method, performed by an access network function node, the method comprising:
sending first indication information to a first network function through a control plane (CP) function, and
wherein the first indication information indicates at least one of:
packet discarding event information of packet data unit (PDU) set based quality of service (QoS) handling, or
packet discarding indication information of a PDU set based QoS handling.

2. The method according to claim 1, wherein
the packet discarding event information indicates a trigger event of packet discarding that achieves condition, and
the packet discarding indication information indicates whether performing the packet discarding that achieves condition is needed, or whether performing the packet discarding that achieves condition is allowed.

3. The method according to claim 2, wherein the trigger event comprises at least one of:
a congestion parameter indicating a level of network congestion is greater than a congestion threshold;
a packet error rate is greater than a packet error rate threshold;
a delay is greater than a delay threshold;
a user equipment (UE) status is a predetermined status; or
a packet discarding filter of a data flow or the PDU set or a data packet is matched.

4. The method according to claim 1, wherein sending the first indication information to the first network function through the CP function comprises:
sending the first indication information to the first network function through an access and mobility management function (AMF) and a session management function (SMF).

5. The method according to claim 4, wherein sending the first indication information to the first network function through the AMF and the SMF comprises:
sending the first indication information to the AMF, wherein the first indication information is used to be sent to the SMF by the AMF, and is used by the SMF to send second indication information to the first network function, wherein the second indication information carries the first indication information.

6. The method according to claim 4, wherein sending the first indication information to the first network function through the AMF and the SMF comprises:
sending the first indication information to the AMF, wherein the first indication information is used by the AMF to send second indication information carrying the first indication information to the first network function upon receiving the first indication information, and
wherein the second indication information further comprises a measured report.

7. (canceled)

8. The method according to claim 1, wherein the first network function comprises a policy control function (PCF).

9. An information processing method, performed by a first network function, the method comprising:
receiving first indication information sent by an access network function node through a control plane (CP) function,
wherein the first indication information indicates at least one of:
packet discarding event information of packet data unit (PDU) set based quality of service (QoS) handling, or
packet discarding indication information of the PDU set based QoS handling.

10. The method according to claim 9, wherein
the packet discarding event information indicates a trigger event of packet discarding that achieves condition, and
the packet discarding indication information indicates whether performing the packet discarding that achieves condition is needed, or whether performing the packet discarding that achieves condition is allowed.

11. The method according to claim 10, wherein the trigger event comprises at least one of:
a congestion parameter indicating a level of network congestion is greater than a congestion threshold;
a packet error rate is greater than a packet error rate threshold;
a delay is greater than a delay threshold;
a user equipment (UE) status is a predetermined status; or
a packet discarding filter of a data flow or the PDU set or a data packet is matched.

12-15. (canceled)

16. The method according to claim 9, wherein the first network function comprises a policy control function (PCF).

17. The method according to claim 9 further comprises:
sending authorization information to an a session management function (SMF), wherein the authorization information indicates to perform packet discarding on at least one of a QoS flow, a data flow, a data unit set, or a data packet,
wherein the authorization information is used by the SMF to send rule information to a third network function, and the rule information is used by the third network function to perform the packet discarding on at least one of the QoS flow, the data flow, the data unit set, or the data packet, and
wherein sending the authorization information to the SMF comprises:
determining, based on the first indication information, that the packet discarding needs to be performed, and sending the authorization information to the SMF.

18. (canceled)

19. The method according to claim 9, wherein the method comprises:
sending notification information to a second network function;
or,
sending the notification information to the second network function based on received subscription information sent by the second network function;
wherein the notification information comprises at least one of:
a measured report;
the packet discarding event information; or
the packet discarding indication information, and
wherein the second network function comprises a network exposure function (NEF) or an application function (AF).

20-23. (canceled)

24. An information processing method, performed by a third network function, the method comprising:
receiving rule information sent by a session management function (SMF), wherein the rule information is sent by the SMF upon receiving authorization information sent by a first network function,
wherein the authorization information indicates to perform packet discarding on at least one of a quality of service (QoS) flow, a data flow, a data unit set, or a data packet, and
wherein the rule information is used by the third network function to perform the packet discarding on at least one of the QoS flow, the data flow, the data unit set, or the data packet.

25. The method according to claim 24, wherein the method comprises:
performing packet discarding based on a packet data unit (PDU) set parameter, or the rule information, or both.

26. The method according to claim 24, wherein the method comprises at least one of:
performing packet discarding on an entire data packet of a packet data unit (PDU) set or a part of the data packet of the PDU set based on a dependency relationship or an importance relationship of the PDU set;
performing packet discarding within a packet discarding window time;
performing packet discarding based on different data flow priorities; or
performing packet discarding on a packet data unit (PDU) set with a specific dependency relationship or a PDU set with a specific importance relationship.

27. The method according to claim 24, wherein the method comprises at least one of:
performing packet discarding on a packet data unit (PDU) set based on an exceeded PDU set delay budget (PSDB);
performing packet discarding on a packet data unit (PDU) set based on an exceeded PDU set error rate;
performing packet discarding on a packet data unit (PDU) set based on delivery failure of a dependent PDU set;
performing packet discarding on data packet of a packet data unit (PDU) set based on delivery failure of an important PDU set;
performing packet discarding on a packet data unit (PDU) set based on an exceeded packet delay budget (PSDB) of the PDU set;
performing packet discarding on a packet data unit (PDU) set based on an exceeded packet error rate of the PDU set;
performing packet discarding on data packet of a packet data unit (PDU) set based on delivery failure of a dependent packet in the PDU set; or
performing packet discarding on data packet of a packet data unit (PDU) set based on delivery failure of an important packet in the PDU set.

28. The method according to claim 24, wherein the third network function comprises a user plane function (UPF).

29-32. (canceled)

33. A communication device, comprising:
a processor; and
a memory for storing a processor-executable instruction;
wherein the processor is configured to execute the executable instruction to implement the information processing method according to claim 1.

34. A non-transitory computer storage medium, storing a computer-executable program, wherein when the computer-executable program is executed by a processor, the information processing method according to claim 1 implemented.

35-37. (canceled)
